(19) United States
(12) Patent Application Publication
(10) Pub. No.: US 2025/0067095 A1
(43) Pub. Date: Feb. 27, 2025

(54) RECREATIONAL VEHICLE WITH A SLIDING DOOR AND A HANDLE AND/OR LOCKING DEVICE

(71) Applicant: Thor Tech, Inc., Elkhart, IN (US)

(72) Inventors: Erik Plischke, Missen-Willhams (DE); Thomas Schuster, Hergenweiler (DE); Marius Schöll, Bad Hindelang (DE)

(73) Assignee: Thor Tech, Inc., Elkhart, IN (US)

(21) Appl. No.: 18/813,954

(22) Filed: Aug. 23, 2024

(30) Foreign Application Priority Data
Aug. 25, 2023 (DE) 10 2023 122 945.1

(51) Int. Cl. E05C 3/14; E05C 3/00

(52) U.S. Cl. CPC E05C 3/145; E05C 3/004

(57) ABSTRACT

A handle and/or locking device for a sliding door of recreational vehicles, in particular a motorhome or caravan, with a grip recess, an actuating element and a mounting plate, wherein the mounting plate is connected to the handle shell in a fixed position relative to the handle shell, wherein the actuating element is pivotably mounted between the handle shell and the mounting plate, and wherein the handle shell has a recess which allows actuation of the actuating element. Furthermore, a sliding door and a recreational vehicle are specified.

The invention relates to a recreational vehicle, in particular a motorhome or a caravan, as well as a sliding door and a handle and/or locking device for a sliding door.

When constructing RV furniture, push-locks can be used for swinging doors or drawers. Furthermore, drawers with snap locks that are activated by pressure can be used in furniture construction. In addition, sliding doors can be realized with a pressure lock or pressure actuator.

The object of the invention is to provide a handle and/or locking device for a sliding door of recreational vehicles, which allow an improved design and functionality.

The object is achieved by a handle and/or locking device with the features of independent claim 1, by a sliding door with the features of claim 9, and a recreational vehicle with the feature of claim 10. Advantageous further developments of the invention are given in the sub-claims.

The object is achieved by a handle and/or locking device for a sliding door of recreational vehicles, in particular motorhomes or caravans, with a handle shell, an actuating element and a mounting plate, wherein the mounting plate is connected to the handle shell in a fixed position relative to the handle shell, wherein the actuating element is pivotably mounted between the handle shell and the mounting plate and wherein the handle shell has a recess which allows actuation of the actuating element.

The object is further achieved by a sliding door for a recreational vehicle, in particular a motorhome or a caravan, with a door leaf which has a recess and such a handle and/or locking device which is inserted into the recess of the door leaf and is connected to the door leaf. The object is further achieved by a recreational vehicle, in particular a motorhome or a caravan, with at least one such sliding door.

In particular, a symmetrically designed lock or handle for a sliding door can be realized by the handle and/or locking device. A very flat design is possible, so that an area of application also arises for such cases. The handle and/or locking device can be designed so that it can be used on both the left and right. Furthermore, a simple structure can be realized without complex mechanics. Furthermore, a low weight can be realized. This makes the handle and/or locking device particularly suitable for lightweight construction, in particular an interior fitting made of lightweight panels, for a recreational vehicle. Furthermore, a small number of parts can be realized. In addition, simple installation can be realized.

In an advantageous embodiment, one or more components of the handle and/or locking device can be designed as injection-molded parts. A door leaf on which the handle and/or locking device is mounted can be constructed from a lightweight panel. Low costs and easy installation can be achieved.

It is advantageous that the handle shell has a grip recess that opens outwards and that the actuating element extends through the recess in the handle shell into the grip recess of the handle shell, at least in the non-actuated state. This allows for advantageous operation by a user. Furthermore, a particularly flat design can be realized.

It is advantageous that the actuating element is pivotably mounted on a pin provided on the handle shell. Specifically, the actuating element can be pivotably mounted on a pin formed on the handle shell. This results in a design with a small number of components. The pin can in particular be formed on a handle shell designed as an injection-molded part.

It is advantageous that the mounting plate is connected, in particular screwed, to the handle shell by means of the pin of the handle shell. This means that the pin can also be used to attach the mounting plate.

It is advantageous that at least one spring element is provided which is connected on the one hand to the handle shell and on the other hand to the actuating element, and that the spring element is prestressed such that the non-actuated actuating element is held in the non-actuated position. In particular, locking can be ensured in the non-actuated position. The lock can then be released by actuating the actuating element against the spring force.

It is advantageous that the spring element is connected to a pin provided, in particular formed, on the handle shell. This pin can also be used to attach the mounting plate to the handle shell, in particular by screwing it on. The pin can be molded on accordingly. Specifically, the handle shell can be designed as an injection-molded part, with the pin being molded onto it.

It is advantageous that a recess is provided on the mounting plate in which a counterholder is arranged when the sliding door is closed, and that a locking piece, in particular a locking lug, of the actuating element engages in the counterholder when the sliding door is in the closed state. The counterholder can, for example, be attached to a piece of furniture, in particular to a profile of the furniture. This makes easy installation possible. Furthermore, universal applicability can be achieved.

It is advantageous that the locking piece is designed in such a way that, when the sliding door is closed, the actuating element can be pivoted back and forth so that the locking piece engages in the counterholder in the closed state. This allows for self-locking when the sliding door is closed.

In a preferred application, the sliding door is part of a piece of furniture. In this case, one or more sliding doors can be provided on a piece of furniture.

Depending on the design, one or more of the following features and advantages can be realized. Specifically, a symmetrically designed lock or a symmetrically designed handle for a sliding door can be realized by the handle and/or locking device. The handle and/or locking device can preferably be mounted in just a few simple steps. A large and flat mounting plate allows a solid installation situation to be achieved even with thin panels. Furthermore, the actuating element can preferably also be mounted upside down on the handle shell, so that a left as well as a right version can be created. The actuating element can be designed as a handle element.

When locking, the actuating element can rotate upwards when closing and then snap into the counterholder.

Furthermore, a very simple construction for sliding doors made of very flat and light materials is possible. For example, a sliding door with a thickness of 10 mm can be realized. The flow of force of the actuating element (handle) can be optimally introduced into the sliding door through the large, flat mounting plate. This can ensure reliable functionality even when using the smallest screws for connection. Furthermore, intuitive opening and closing can be made possible.

Pre-assembly of the module can be made possible by preferably requiring fewer steps. Replacing the sliding door or the handle and/or locking device can be done in just a few steps. Furthermore, cost-effective volume production can be realized.

The spring element can be considered as an optional component. If necessary, a spring-loaded plastic extension of the actuating element can be provided instead of a spring element. Thus, the handle and/or locking device can also be realized without a spring element. This allows the number of components to be further reduced. This also simplifies installation.

Further advantages and details of the invention are explained in more detail with reference to the exemplary embodiments shown in the schematic figures. In the figures:

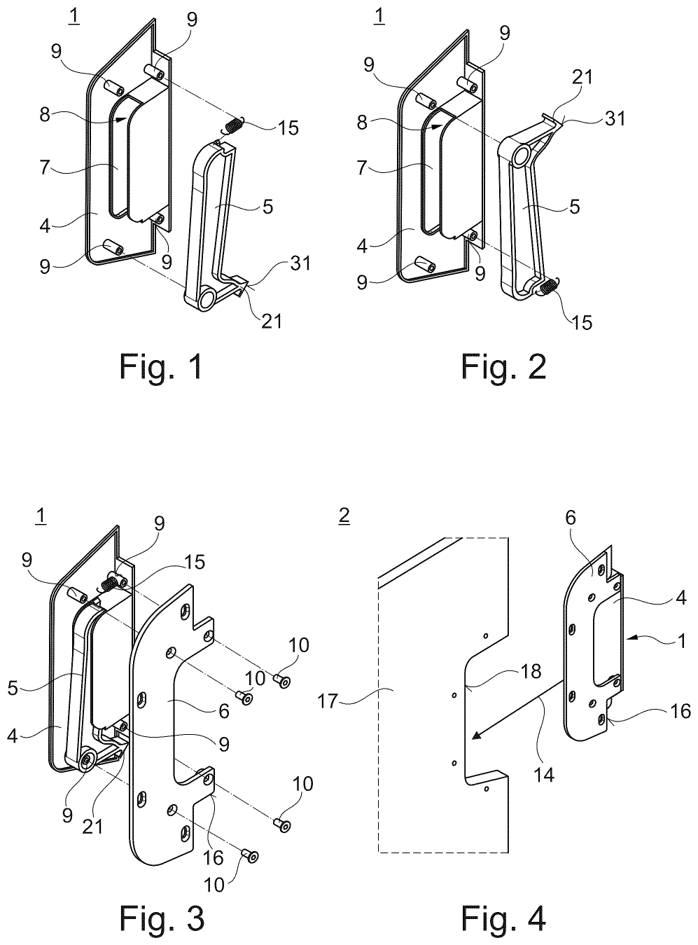

FIG. 1 shows a handle and/or locking device during installation corresponding to a first application for a left sliding door in a schematic, spatial representation;

FIG. 2 shows the handle and/or locking device shown in FIG. 1 for a further application corresponding to a right sliding door;

FIG. 3 shows the handle and/or locking device shown in FIG. 1 during installation in an exploded view, wherein a mounting plate is mounted;

FIG. 4 shows the handle and/or locking device shown in FIG. 3 with a door leaf to explain the design of a sliding door;

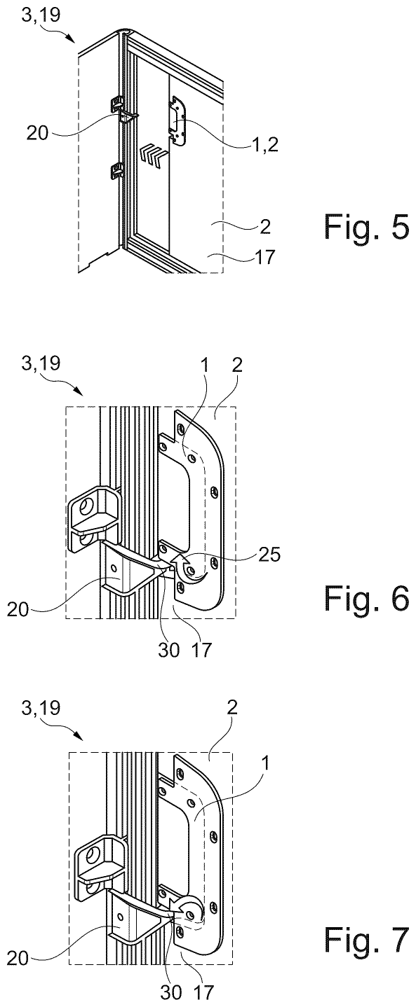

FIG. 5 shows a piece of furniture with a sliding door in an excerpted, spatial, schematic representation;

FIG. 6 shows a detail of the furniture of the recreational vehicle shown in FIG. 5 when closing, and

FIG. 7 shows the detail of the furniture shown in FIG. 6 with the sliding door in the closed state.

FIG. 1 shows a handle and/or locking device 1 for a sliding door 2 (FIG. 5) of recreational vehicles 3 in an excerpted, schematic, spatial representation according to an exemplary embodiment. A recreational vehicle 3 can be designed here particularly as a motorhome or caravan. The handle and/or locking device 1 and the sliding door 2 are particularly suitable for such recreational vehicles 3.

The handle and/or locking device 1 has a handle shell 4 and an actuating element 5. The actuating element 5 can preferably be mounted in different ways, with FIG. 1 showing one possible installation.

In the following, the design of the handle and/or locking device 1 is further described with reference to FIGS. 2 and 3.

FIG. 2 shows the handle and/or locking device 1 shown in FIG. 1, wherein the actuating element 5 is mounted, in a sense, the other way around. For example, the installation according to FIG. 1 can be used for a left sliding door 2, while the installation shown in FIG. 2 is used for a right sliding door 2.

As shown in FIG. 3, the handle and/or locking device 1 also has a mounting plate 6. The mounting plate 6 is connected to the handle shell 4 so that the handle shell 4 and the mounting plate 6 are mounted in a fixed position relative to each other. The actuating element 5 is pivotably mounted between the handle shell 4 and the mounting plate 6. The handle shell 4 has a recess 7 into which the actuating element 5 is partially inserted. The recess 7 thus ensures that the actuating element 5 can be actuated by a user.

In this exemplary embodiment, the handle shell 4 has a grip recess 8 that is open to the outside, wherein the actuating element 5 extends through the recess 7 of the handle shell 4 into the grip recess 8 of the handle shell 4. The actuating element 5 can serve as a handle. The handle shell 4 and the actuating element 5 are designed such that a symmetrical installation is possible according to the installation positions shown in FIGS. 1 and 2.

The actuating element 5 is pivotably mounted on a pin 9 of the handle shell 4. In this embodiment, one of two pins 9 can be selected to allow installation via the left or right sliding door 2.

Furthermore, the mounting plate 6 is connected to the handle shell 4 via the pins 9 of the handle shell 4. Screws 10 can be screwed into the pins 9 so that a connection is made by screwing.

In addition, a spring element 15 is provided, which is connected on the one hand to the handle shell 4 and on the other hand to the actuating element 5. The spring element 15 is preloaded during installation. As a result, the spring element 15 holds the actuating element 15 in a position which allows locking when the sliding door 2 is closed, as is also described in more detail with reference to FIGS. 5 to 7. For this purpose, the mounting plate 6 has a recess 16.

FIG. 4 shows a door leaf 17 and the handle and/or locking device 1 for producing a sliding door 2. The door leaf 17 has a recess 18 into which the handle and/or locking device 1 is inserted as indicated by the arrow 14.

FIGS. 5 to 7 show a piece of furniture 19 of the recreational vehicle 3 in an excerpted, schematic representation. Here, FIGS. 6 and 7 show details of FIG. 5 when the sliding door 2 is closed.

As shown in FIG. 3, the spring element 15 is connected to a pin 9. The actuating element 5 is held in the position shown in FIG. 3. The piece of furniture 19 has a counterholder 20. The actuating element 5 has a locking piece 21 which, as shown in FIGS. 6 and 7, cooperates with the counterholder 20.

During the closing movement, the spring element 15 is further tensioned by pivoting the actuating element 5. The locking piece 21 is raised slightly as indicated by the arrow 25. In the process, the counterholder 20 enters the recess 16.

The locking piece 21 is designed as a locking lug 21 so that the locking piece 21 is lifted by the counterholder 20. The locking piece 21 then latches into the counterholder 20. The sliding door 2 is then locked.

To lift the locking piece 21, a projection 30 of the counterholder 20 can cooperate with a lug flank 31 (FIG. 1).

The invention is not limited to the embodiments described.

1. A handle and/or locking device for a sliding door of recreational vehicles, in particular motorhomes or caravans, with a handle shell, an actuating element and a mounting plate, wherein the mounting plate is connected to the handle shell in a fixed position relative to the handle shell, wherein the actuating element is pivotably mounted between the handle shell and the mounting plate, and wherein the handle shell has a recess which allows actuation of the actuating element.

2. The handle and/or locking device according to claim 1,
characterized in that
the handle shell has a grip recess that opens outwards and that the actuating element extends through the recess of the handle shell into the grip recess of the handle shell, at least in the non-actuated state.

3. The handle and/or locking device according to claim 1,
characterized in that
the actuating element is pivotably mounted on a pin provided, in particular formed, on the handle shell.

4. The handle and/or locking device according to claim 3,
characterized in that
the mounting plate is connected, in particular screwed, to the handle shell by means of the pin of the handle shell.

5. The handle and/or locking device according to claim 1,
characterized in that
at least one spring element is provided which is connected on the one hand to the handle shell and on the other hand to the actuating element, and that the spring element is prestressed such that the non-actuated actuating element is held in the non-actuated position.

6. The handle and/or locking device according to claim 5,
characterized in that
the spring element is connected to a pin provided, in particular formed, on the handle shell.

7. The handle and/or locking device according to claim 1,
characterized in that
a recess is provided on the mounting plate in which a counterholder is arranged when the sliding door is in the closed state, and that a locking piece, in particular a locking lug, of the actuating element engages in the counterholder when the sliding door is in the closed state.

8. The handle and/or locking device according to claim 7,
characterized in that
the locking piece is designed such that, when the sliding door is closed, the actuating element can be pivoted back and forth such that the locking piece engages in the counterholder in the closed state.

9. A sliding door for a recreational vehicle, in particular a motorhome or a caravan, with a door leaf which has a recess, and a handle and/or locking device according to claim 1, which is inserted into the recess of the door leaf and is connected to the door leaf.

10. A recreational vehicle, in particular a motorhome or caravan, with at least one sliding door according to claim 9.

11. The recreational vehicle according to claim 10,
characterized in that at least one piece of furniture is provided which has at least one sliding door.
